(19) United States
(12) Patent Application Publication
(10) Pub. No.: US 2015/0122654 A1
(43) Pub. Date: May 7, 2015

(54) SYSTEM AND METHOD FOR IMPROVING OIL-WATER SEPARATOR PERFORMANCE

(71) Applicant: Caltec Limited, Bedfordshire (GB)

(72) Inventors: Mirza Najam Ali Beg, Milton Keynes (GB); Carl Wordsworth, Bedfordshire (GB)

(73) Assignee: Caltec Limited, Bedfordshire (GB)

(21) Appl. No.: 14/401,918

(22) PCT Filed: May 10, 2013
(86) PCT No.: PCT/GB2013/051209

§ 371 Date: Nov. 18, 2014

(30) Foreign Application Priority Data
May 25, 2012 (GB) 1209343.1
Jun. 1, 2012 (GB) 1209973.5
Sep. 18, 2012 (GB) 1216589.0

(51) Int. Cl. B01D 17/06; B01D 17/02; B01D 17/04; B03C 11/00

(52) U.S. Cl. CPC B01D 17/06; B03C 11/00; B01D 17/0217; B01D 17/045; B03C 2201/02
USPC 204/555; 204/666; 204/573; 204/661

(57) ABSTRACT

A system for improving oil-water separator performance wherein an electrostatic coalescer (15) is located upstream of a cyclonic oil-water separator (16). Preferably, the electrostatic coalescer is able to be bypassed and/or is located in parallel with a mechanical coalescer (17). In the case of parallel arrangement, selection of the flow path route between the electrostatic coalescer (15) and mechanical coalescer (17) is determined by use of an upstream phase detector (18).

### CROSS REFERENCE TO RELATED APPLICATIONS

This application claims foreign priority benefits under 35 U.S.C. §119(a)-(d) to GB1209343.1 filed May 25, 2012, GB1209973.5 filed Jun. 1, 2012, GB1216589.0 filed Sep. 18, 2012 and PCT/GB2013/051209 filed May 10, 2013, which are incorporated by reference in their entirety and relied upon.

### BACKGROUND OF THE INVENTION

1. Field of the Invention

The present invention relates to a system and method for using electrostatic coalescence to improve oil-water separator performance in the oil and gas industry. Particularly, the invention seeks to extend the operating envelope of currently used oil-water separator apparatus, such as that described by WO2009/092998A2, the content of which is incorporated herein by reference.

2. Description of Related Art

The system of WO2009/092998 (illustrated in FIG. 1 of the attached drawings) separates a fluid mixture by utilising a uniaxial cyclonic separator (1) having a first inlet (labelled “IN”) for receiving a fluid mixture, a separation chamber (2) for separating the fluid mixture by cyclonic action into a dense first fluid and a less dense second fluid, a first outlet (3) for the first fluid and a second outlet (4) for the second fluid. The system further includes a reverse flow cyclonic separator (5) having an inlet for receiving the first fluid from the first outlet (3), a separation chamber for separating the first fluid by cyclonic action into a dense third fluid and a less dense fourth fluid, a third outlet (6) for the third fluid and a fourth outlet (7) for the fourth fluid.

Such a system only provides useful separation when the fluids entering the unit are in the water continuous regime (i.e. generally 50% water or more). However, when the fluid is oil continuous (i.e. less than 50% water) it becomes very difficult to extract small droplets of water through the more viscous oil phase. This can be observed in separation tests completed with an oil continuous fluid, e.g. generally if there is a 30% inlet water cut entering the separator unit, the water outlet may increase to 50 or 60%, so some separation is being undertaken, but the level is not high enough for the existing fluids to become suitable for downstream discharge or polishing units.

### BRIEF SUMMARY OF THE INVENTION

As mentioned, the present invention is concerned with extending the operating envelope of a currently used oil water separator apparatus. This is achieved by implementing a method and apparatus/system according to claim 1.

In a broad aspect of the invention there is provided a system for improving oil-water separator performance wherein an electrostatic coalescer is located upstream of a cyclonic oil-water separator.

Preferably the electrostatic coalescer is located in parallel with a mechanical coalescer such that the input path to the cyclonic oil-water separator is selectable as having been routed through the electrostatic coalescer and/or mechanical coalescer. Alternatively, the electrostatic coalescer may be bypassed without the implementation of a mechanical coalescer located in the bypass. In a further form the system may incorporate an electrostatic coalescer, mechanical coalescer and a bypass line in parallel such that there are three possible paths for the input stream to the oil-water separator.

In a preferred form of the invention, selection of the path between the electrostatic coalescer and mechanical coalescer is determined by use of an oil/water phase sensor.

Preferably, in order for the system to operate with a multiphase inlet fluid stream it will be necessary to remove gas from the fluid stream prior to it entering the coalescers. This can be achieved using known gas liquid separation technology, e.g. as in GB2453586 which describes a cyclone and gravity separator combination. Such equipment can be used to provide a liquid free gas stream and a gas free liquid stream. The liquid stream then enters the coalescers and passes through the oil-water separation stage.

US2003/0146175, GB2329849, BRPI0605667, U.S. Pat. No. 5,219,471 and U.S. Pat. No. 4,116,790 describe examples of methods/systems for separating oil-water mixtures; however, none is arranged according to the total system of the invention. Specifically, the invention is differentiated by use of two coalescers (one mechanical and one electrical in parallel) and a flow inversion detector to switch flow from one to another coalescer when needed. Hence the system extends the operation range of Wx over oil phase and water phase continuous operations.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 illustrates a prior art cyclonic separator as known from WO2009/092998; and

FIG. 2 illustrates a system according to the invention.

### DETAILED DESCRIPTION OF THE INVENTION

Referring to the figures, wherein like numerals indicate like or corresponding parts throughout the several views, FIG. 2 shows a system where a multiphase (gas and water/oil) fluid carrying line 11 is firstly directed into a two stage separation apparatus 12 where gas is removed from the fluid stream. Separated gas makes its way directly to an outlet 13 for further processing as known in the art.

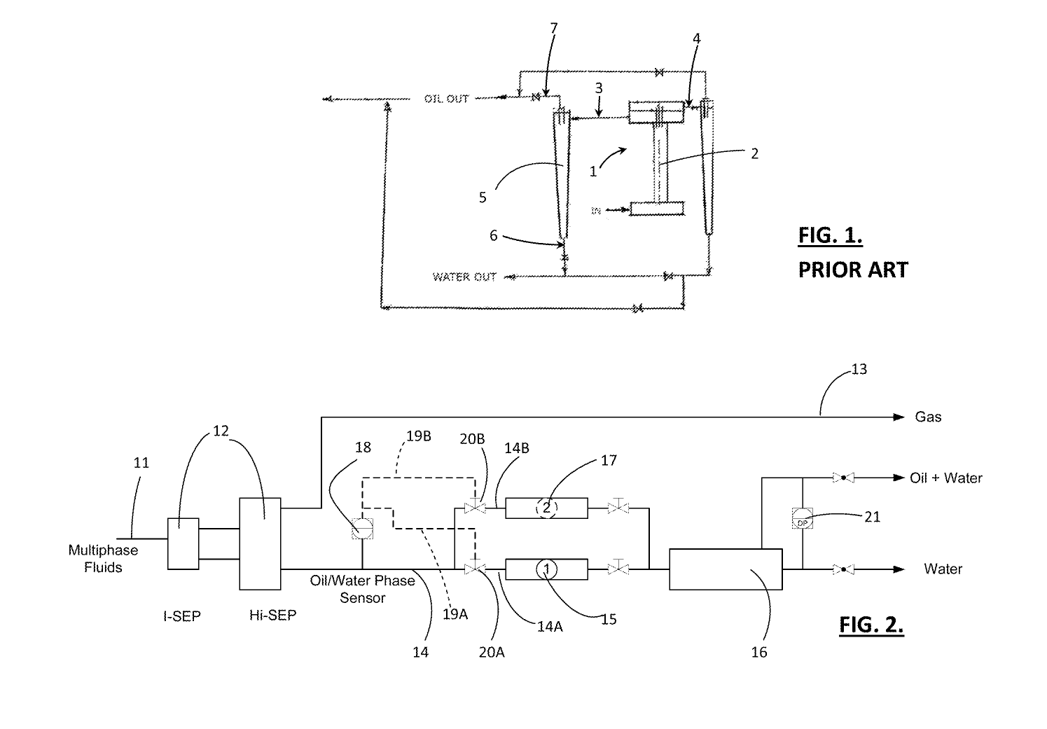

According to the invention the oil/water fluid mixture line 14 is able to be passed through an electrostatic coalescer 15, via line 14A, prior to a cyclonic oil-water 16, e.g. of the type described by WO2009/092998 (FIG. 1).

The operating principle behind implementing an electrostatic coalescer in the system is that, by applying an electrostatic charge across a set of plates in the pipeline, small droplets of water coalesce together, allowing them to form much larger droplets. More particularly, such devices use electrical fields to induce droplet coalescence in water-in-crude-oil emulsions to increase the droplet size. The squared dependence of droplet diameter in Stokes Law increases the settling speed and destabilizes the emulsion. The effects on the water droplet arise from the different dielectric properties of the conductive water droplets dispersed in the insulating oil. Water droplets have a permittivity that is much higher than the surrounding oil (particularly, water with dissolved salt is an even better conductor). When an uncharged droplet is subjected to an AC electric field the field will polarize the droplet creating an electric field around the droplet to counteract the external field. As the water droplet is very conductive the induced charges will reside on the surface. The droplet has no net charge but one positive and one negative side. Inside the droplet the electric field is zero. When two droplets with induced dipoles get close to each other, they will experience a force pulling the droplets closer until they “coalesce” into larger droplets.

If these larger droplets are then passed downstream into the oil-water separator, it becomes easier for that unit to separate them as they are of higher mass, therefore it is easier for the ‘g’ forces in the cyclonic separator to pull the larger droplets together and a better degree of separation is achieved.

However, an electrostatic coalescer cannot be used when the fluid is in a water continuous phase (50% water or more) as this tends to short circuit the system. Therefore a bypass arrangement is preferable in the system (as suggested in FIG. 2 by selectable fluid line 14B) so that once the system becomes water continuous the electrostatic coalescer can be bypassed and the oil-water separator stage will operate on its own. Most preferably, as illustrated, a mechanical coalescer 17 is installed in line 14B to process the bypassed water continuous phase. In effect this second coalescer unit 17 is in parallel with the first unit 15. In this way electrostatic coalescer 15 would be used for oil continuous flows whilst mechanical coalescer 17 would be used for water continuous flows.

In order to monitor the need for switching between the lines 14A and 14B, the input oil/water fluid mixture line 14 preferably incorporates a sensor 18 to determine the proportion of water or oil. Use of such an upstream probe 18 in the system could enable automation of the process by detecting the phase change. Automation is denoted by dotted lines 19A and 19B where a control means actuates valves 20A and 20B to select between routing through the electrostatic coalescer 15 (line 14A) or mechanical coalescer 17 (line 14B) respectively. Accordingly, further improvements in the performance of the oil-water separator 16 in a water continuous flow regime are possible. As indicated in FIG. 2, the outlet side of the separator 16 is a water and oil+water (but greatly reduced water content) stream.

Further aspects of the invention include the utilisation of an upstream phase detector 21, parallel electrostatic/mechanical coalescer (or potentially a series of first mechanical then electrostatic coalescer), bulk oil-water separator control system and actuated valves; although manual valves could be implemented if required.

The system of the present invention utilises components which are generally known in the art, but arranged in a new way to achieve improvement in separation between oil and water.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A system for improving oil-water separator performance wherein an electrostatic coalescer is located upstream of a cyclonic oil-water separator.

2. The system of claim 1 wherein the electrostatic coalescer is able to be bypassed.

3. The system of claim 1 further including a mechanical coalescer upstream of the cyclonic oil-water separator.

4. The system of claim 3 wherein the electrostatic coalescer is located in parallel with the mechanical coalescer such that the input path to the downstream cyclonic oil-water separator is able to be routed through the electrostatic coalescer and/or mechanical coalescer.

5. The system of claim 4 wherein selection of path routing between the electrostatic coalescer and mechanical coalescer is determined by use of an upstream phase detector.

6. The system of claim 1 wherein a gas liquid separator is located upstream of the electrostatic coalescer such that an outlet gas stream is separated from the fluid stream able to be processed by the electrostatic coalescer.

7. The system of claim 6 wherein the gas liquid separator is a cyclone and gravity separator combination.

8. A method for improving oil-water separator performance wherein an electrostatic coalescer is installed upstream of a cyclonic oil-water separator.

9. The method of claim 8 wherein a mechanical coalescer is installed in parallel with the electrostatic coalescer such that the input path to the downstream cyclonic oil-water separator is selectable to be routed through the electrostatic coalescer and/or mechanical coalescer.

10. The method of claim 8 wherein a bypass line is installed in parallel with the electrostatic coalescer.

11. The method of claim 10 wherein the routing path is switchable either by manual operation of shut-off valves or by automation by a control means actuating control valves.

12. The method of claim 11 wherein the need for switching, either manually or automatically, is determined by a phase detector installed upstream of the coalescers.

13. The method of claim 8 wherein a gas liquid separator is located upstream of the electrostatic coalescer such that an outlet gas stream is separated from the fluid stream able to be processed by the electrostatic coalescer.

14. An apparatus for oil-water separation wherein an electrostatic coalescer is located in a line upstream of a cyclonic oil-water separator.

15. The apparatus of claim 14 further incorporating a bypass line in parallel with the electrostatic coalescer.

16. The apparatus of claim 14 further incorporating line with a mechanical coalescer in parallel with the electrostatic coalescer.

17. The apparatus of claim 16 wherein the lines are selectable.

18. The apparatus of claim 17 including a phase detector and control means to determine selection.
